(19) United States
(12) Patent Application Publication
(10) Pub. No.: US 2022/0304224 A1
(43) Pub. Date: Sep. 29, 2022

(54) LAWN MOWER WITH TRIMMER

(71) Applicant: Sandco Strimower Ltd, Dartford (GB)

(72) Inventor: Samuel James COOGAN, Dartford (GB)

(73) Assignee: Sandco Strimower Ltd, Dartford (GB)

(21) Appl. No.: 17/639,035

(22) PCT Filed: Aug. 28, 2020
(86) PCT No.: PCT/GB2020/052067

§ 371 Date: Feb. 28, 2022

(30) Foreign Application Priority Data
Aug. 30, 2019 (GB) 1912474.2

(51) Int. Cl. A01D 34/66; A01D 34/416; A01D 43/16

(52) U.S. Cl. CPC A01D 34/662; A01D 34/416; A01D 43/16; A01D 2101/00

(57) ABSTRACT

A lawn mower (100) comprising a wheeled carriage (102) configured to carry a primary cutting tool (105) for cutting lawn, the primary cutting tool (105) being operably coupled to a primary drive system. The mower (100) also comprises a trimmer (106) operably coupled to the wheeled carriage (102), and a translation mechanism comprising a selectable static state and a selectable dynamic state. The translation mechanism (110, 112, 114, 116, 118, 120) is operably coupled to the trimmer (106) and configured to permit horizontal translation of the trimmer (106) in front of the wheeled carriage (102) in response to selection of the dynamic mode.

The present invention relates to a lawn mower of the type that, for example, comprises a trimmer for trimming edges that a primary cutting tool of the lawn mower cannot reach.

In the field of cutting lawn, it is known to provide a mower having a primary cutting tool, for example a rotating blade. In many, but not all implementations, the rotating blade is provided on the underside of a wheeled carriage, although it is known to provide rotating drum-like cutting blades to the front of the wheeled carriage in other implementations. Furthermore, proposals exist to provide the mower with a trimmer for cutting edges of a lawn that cannot be readily cut using the primary cutting tool.

For example, U.S. Pat. No. 2,771,730 discloses a mower comprising a side-mounted arm that carries a trimmer. The arm is coupled to a wheeled carriage of the mower and can be raised and lowered in order to raise and lower the trimmer.

U.S. Pat. No. 6,094,896 discloses a mower comprising a trimmer assembly mounted to the front of a wheeled carriage of the mower by a mounting assembly. The mounting assembly comprises a pair of arms to permit the trimmer assembly to be raised and lowered so as to deploy the trimmer when needed and stow the trimmer when not required.

Like U.S. Pat. Nos. 6,094,898, 6,474,053 provides a trimmer carried by a mower on a corner-mounted deployment arm, which enables the trimmer to be stowed when not in use but parallel to the front of the mower in the case of U.S. Pat. No. 6,094,898. To deploy the trimmer, the arm swings outward to one side of the mower for use in the deployed state, i.e. the trimmer is only used when fully in the deployed state.

However, known mowers equipped with trimmers suffer from a number of disadvantages. In this respect, the above-described trimmers are intended to be used in a single position relative to the wheeled carriage, which is either in the centre relative to the wheeled carriage or to one side of the wheeled carriage. Trimming around so-called “features” of a lawn is therefore challenging and the trimming configuration lacks the flexibility to cope with different trimming scenarios, for example borders or central features. For instance, maneuverability during trimming using the above mowers is also limited, because the trimmer is in a fixed location, particularly when appended to one side of the mower, and so mowing and trimming into corners can be difficult and labour intensive. Additionally, the above mowers are somewhat bulky and/or deploy the trimmer at, relatively speaking, a considerable distance from the front of the mower.

Furthermore, the use of multiple trimmer heads in respect of some known mower and trimmer combinations leads to an increase in build and supply costs owing to the need for additional components to provide multiple trimmers. Such trimmers also increase storage demands, shipping costs and have an increased susceptibility to damage.

Additionally, the primary cutting tool and the trimmer of the above mowers share a common power source that places a higher energy demand on the drive system to power both the mower and trimmer continuously while the mower is powered up, which is inefficient. Additionally, having all cutting elements active continuously is potentially hazardous and subjects the trimmer to unnecessary wear.

Also, where the trimmers used employ portions of rotating nylon flex or the like, rotation and therefore activation of the trimmer is difficult to observe. Users with impaired hearing or any user in a noisy environment may therefore have difficulty knowing when the trimmer is active and therefore potentially hazardous.

Additionally, where the terrain of a lawn is uneven, the trimmers can be susceptible to snagging on the earth from which the lawn grows, thereby causing the mower to lose traction and/or causing damage to the trimmer and/or mounting assembly. Also, uneven trimming heights can result as the trimmers are typically maintained in fixed relation to the wheeled carriage of the mower.

According to a first aspect of the present invention, there is provided a lawn mower comprising: a wheeled carriage configured to carry a primary cutting tool for cutting lawn, the primary cutting tool being operably coupled to a primary drive system; a trimmer operably coupled to the wheeled carriage; a translation mechanism comprising a selectable static state and a selectable dynamic mode, the translation mechanism being operably coupled to the trimmer and configured to permit horizontal translation of the trimmer in front of the wheeled carriage in response to selection of the dynamic mode; a mounting arm configured to carry to the trimmer; a ground-engaging underside surface element configured to ride over contours of a lawn, when in use, without snagging; and a bias unit configured to bias the mounting arm downwardly.

The trimmer may be removably coupled to the wheeled carriage.

The translation mechanism may comprise rear wheels of the wheeled carriage having a fixed state and a steering state.

The translation mechanism may comprise the mounting arm horizontally pivotally mounted.

The mounting arm may have a fixed state and a pivoting state.

The mounting arm may be configured to power the trimmer.

The mounting arm may power the trimmer mechanically or the mounting arm may power the trimmer electrically.

The pivotally mounted arm may be configured to sweep from side-to-side.

Movement of the pivotally mounted arm may be controllable remotely.

The pivotally mounted arm may be centrally mounted.

The lawn mower may further comprise: a secondary drive system configured to drive the trimmer; the secondary drive system may be independently controllable from the primary drive system.

The ground-engaging underside surface element may comprise a forward-facing curved portion extending towards the trimmer.

The ground-engaging underside element may be a skid pan.

The ground-engaging underside element may be a wheel.

The lawn mower may further comprise a front mounted light source. The light source may be configured to strobe at a frequency configured to permit visibility of rotation of the trimmer.

According to a second aspect of the invention, there is provided a lawn mower comprising: a wheeled carriage configured to carry a primary cutting tool for cutting lawn, the primary cutting tool being operably coupled to a primary drive system; a first fixed mounting point located at the front of the wheeled carriage relative to a primary direction of locomotion of the wheeled carriage; a second fixed mounting point located at the front of the wheeled carriage; a trimmer removably couplable to the first fixed mounting point or the second fixed mounting point; a mounting arm configured to carry to the trimmer; a ground-engaging underside surface element configured to ride over contours of a lawn, when in use, without snagging; and a bias unit configured to bias the mounting arm downwardly; wherein the first and second fixed mounting points are disposed in spaced relation to each other.

The first and second fixed mounting points may be configured to power the trimmer when coupled respectively to the first and second fixed mounting points.

The each of the first and second fixed mounting points may power the trimmer mechanically or the each of the first and second fixed mounting points may power the trimmer electrically.

The lawn mower may further comprise: a plurality of fixed mounting points disposed about the front of the wheeled carriage; the plurality of fixed mounting points may comprise the first and seconds fixed mounting points and each of the plurality of fixed mounting points may be configured to carry the trimmer.

A fixed mounting point of the first and second fixed mounting points may be substantially corner mounted with respect to the wheeled carriage.

The lawn mower may further comprise a bias unit configured to bias downwardly the trimmer when coupled to a mounting point of the plurality of mounting points.

According to a third aspect of the invention, there is provided a trimmer for a lawn comprising an arm configured to carry a trimmer head, and a downward bias element configured to cooperate with the arm in order to urge, when in use, the trimmer downwardly and/or a ground-engaging underside surface element configured to ride over contours of a lawn without snagging. The trimmer may comprise the ground-engaging underside element or the arm may comprise the ground-engaging underside element.

It is thus possible to provide a mower that provides greater maneuverability and flexibility when trimming lawns, particularly but not exclusively where the lawn has corners and/or features that constitute obstacles. The trimmer is also less susceptible to snagging on the surface of the lawn when the terrain of the lawn is uneven. Furthermore, the mower with trimmer is able to provide an improved consistency of cutting height. The use of a trimmer that is detachable facilitates improved storage efficiency as well as obviating the need for multiple trimmers to be coupled to the mower. The mower and trimmer combination is therefore less expensive to manufacture and also less wasteful of materials. Packaging of the mower and trimmer combination is also improved. As a result of independent powering and control of the trimmer with respect to the primary cutting tool of the mower, the trimmer serves to improve user safety, and the ability to determine visually when the trimmer is operational improves safety too. The ability to power the trimmer independent of the primary cutting tool of the mower results in lower power requirements than if the primary cutting tool, locomotion system and trimmer were powered continuously together by a common drive system.

At least one embodiment of the invention will now be described, by way of example only, with reference to the accompanying drawings, in which:

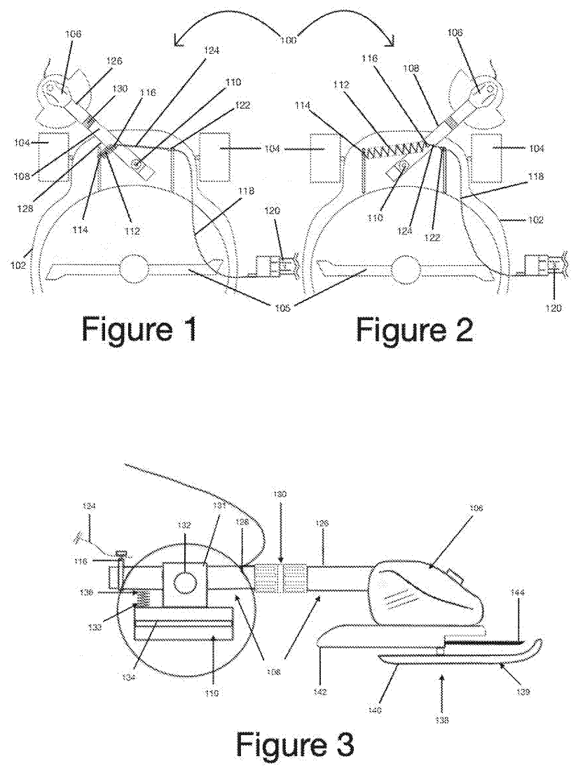

FIG. 1 is a schematic plan view of a mower comprising a trimmer in a first operational position and constituting an embodiment of the invention;

FIG. 2 is a schematic plan view of the mower of FIG. 1 having the trimmer in a second operational position;

FIG. 3 is a schematic side elevation of an arm and the trimmer of FIGS. 1 and 2 constituting another embodiment of the invention;

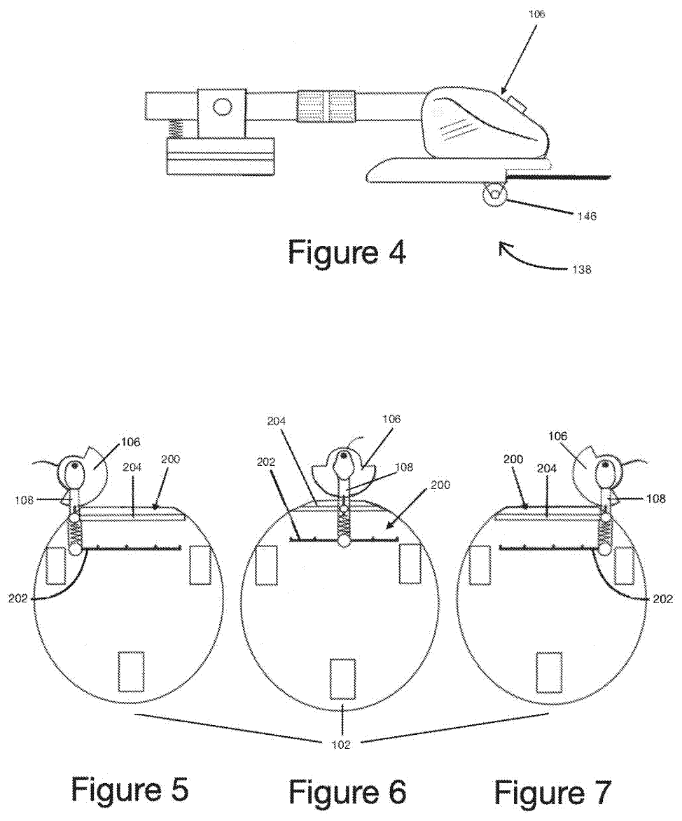

FIG. 4 is a schematic side elevation of an alternative arm and trimmer to the arm and trimmer of FIG. 3 and constituting another embodiment of the invention;

FIGS. 5 to 7 are schematic plan views of another mower comprising a trimmer constituting a further embodiment of the invention;

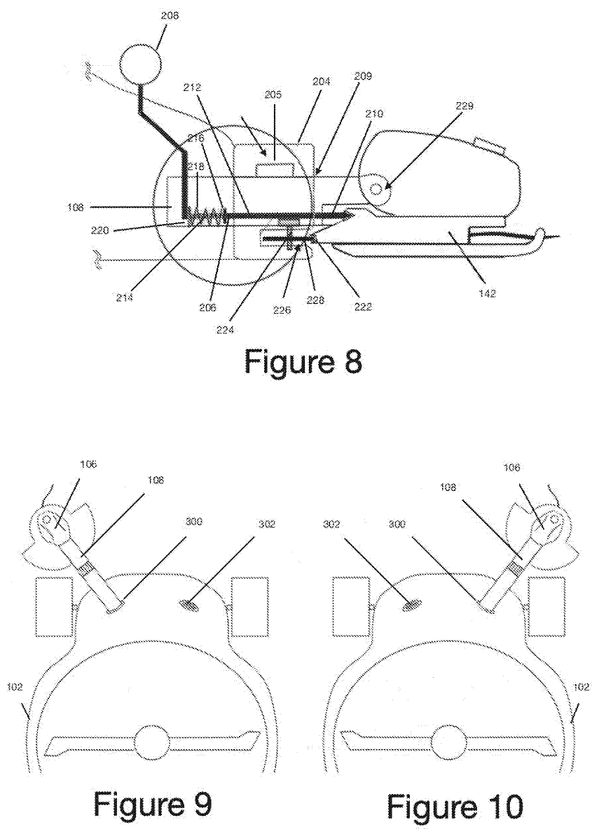

FIG. 8 is a schematic side elevation of the trimmer of FIGS. 5 to 7;

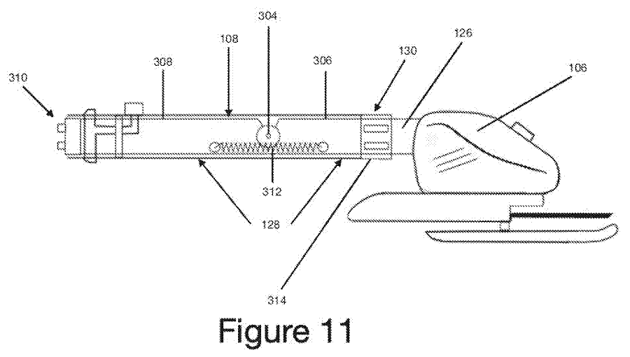

FIGS. 9 and 10 are schematic plan view of a mower comprising a trimmer constituting yet a further embodiment of the invention; and

FIG. 11 is a schematic side elevation of an arm and a trimmer for use with mower of FIGS. 9 and 10.

Throughout the following description, identical reference numerals will be used to identify like parts.

Referring to FIG. 1, a mower with trimmer 100 comprises a wheeled carriage 102 comprising front wheels 104 and rear wheels or a roller (not shown). A primary cutting tool 105, for example a rotatable cutting blade, is operably coupled to a primary drive system (also not shown) so as to power and drive the primary cutting tool 105. A trimmer 106 is operably coupled to the wheeled carriage 102 of the mower 100, the trimmer 106 being carried on an arm 108, a distal end of which in this example is pivotally mounted to the wheeled carriage 102, for example using a ball-bearing joint 110. In this example, the arm 108 and the trimmer 106 are centrally mounted. In some examples, all or part of the arm 108 carrying the trimmer 106 and/or the trimmer 106 can be detachable from the wheeled carriage 102 or a coupling thereof.

A translation mechanism is provided to move the trimmer 106 coupled to the arm 108 from side-to-side horizontally in front of the wheeled carriage 102. In this respect, a biasing means, for example a first, tensioning, spring 112 has a first end coupled to a first anchoring point 114 disposed at a first side and towards the front of the wheeled carriage 102 opposite an end of the arm 108 distal from the trimmer 106. A second end of the tensioning spring 112 is coupled to a common attachment point 116 at the end of the arm 108 distal from the trimmer 106. A gear cable 118 has a first end operably coupled to a selector handle 120. The gear cable 118 comprises an outer sheath and an inner cable 124, the outer sheath of a second end of the gear cable 118 being operably coupled to a second anchoring point 122 disposed at a second side and towards the front of the wheeled carriage 102 opposite the arm 108 and at an opposite side to the first anchoring point 114. The inner cable 124 extends beyond the second anchoring point 122 and is attached to the common attachment point 116 at the end of the arm 108 distal from the trimmer 106.

The arm 108 comprises a first elongate portion 126 and a second elongate portion 128 that share a common longitudinal axis, the first elongate portion 126 being operably coupled to the trimmer 106 at a first end thereof and to the second elongate portion 128 at a second end thereof via an axially rotating and lockable joint 130. A first end of the second elongate portion 128 is operably coupled to the first elongate portion 126 and the second elongate portion 128 is operably coupled at a second end thereof to the wheeled carriage 102 as described above.

Turning to FIG. 3, the arm 108 carrying the trimmer 106 is, in this example, further configured as follows. The arm 108 is further pivotally mounted in a vertical direction to an upper mount 131 of the ball-bearing joint 110 at a pivot point 132. Furthermore, the second end of the second portion 128 of the arm 108, whilst being vertically pivotable, is also urged downwardly by a biasing arrangement, for example a second, downward bias, spring 133 (shown figuratively in FIGS. 3 and 4), operably coupled at one end thereof to a rotating plate 134 of the rotatable ball-bearing joint 110 and to another anchoring point 136 at a distal end of the second portion 128 of the arm 108.

The trimmer 106 has an underside 138 to which a ground-engaging underside surface element, for example a skid pan or plate 140 is coupled. In this example, the ground-engaging underside surface element comprises a forward-facing curved portion 139 that extends upwardly towards the trimmer 106. The trimmer 106 also comprises a guard 142 to ensure only a forward-facing portion of the trimmer 106 is exposed for cutting, for example grass. In this example, the trimmer 106 is configured to deploy cutting flex 144, for example a nylon flex, automatically and the guard 142 also comprises a blade (not shown) configured to cut the cutting flex to a predetermined consistent length as the cutting flex rotates when additional flex is deployed.

Turning to FIG. 4, in another embodiment, instead of the ground-engaging underside surface element being a skid plate 140, a wheel 146 is mounted to the underside 138 of the trimmer 106.

The arm 108 carrying the trimmer 106 can be provided separately as an optional purchase. It therefore follows that in another embodiment, the arm 108 and trimmer 106 comprising the second downward bias spring 133 and/or the skid plate 140 can be a device independent of the mower 100 and the wheeled carriage 102.

In the above-described examples, the trimmer 106 is powered independently of the primary cutting tool 105, and so the trimmer 106 is operably coupled to a second drive system (now shown). The second drive system drives the trimmer 106 either mechanically or electrically via the arm 108. The secondary drive system can be activated remotely via an actuator (not shown) on the selector handle 120 or via any other suitable remote arrangement. The secondary drive system is, in this example, independently controllable of the primary drive system. In this respect, and for the avoidance of doubt, the second drive system can share a common power source, for example a battery.

In operation, the mower 100 is powered by the primary drive system to provide locomotion of the wheeled carriage 102, when a locomotion mode is activated, so as to travel across a lawn (not shown) having a terrain that is typically uneven. As the wheeled carriage 102 passes over the lawn with the primary cutting tool 105 rotating the grass is cut and, optionally, stored in a grass collection bag (not shown) to the rear of the mower 100. When a portion of the lawn needs to be trimmed, for example a border or a central feature having an edge that requires trimming, an operator of the mower activates the trimmer 106, for example using the actuator mentioned above on the selector handle 120, in order to power up the trimmer 106. Once the trimmer 106 reaches operational rotational speed, the trimmer can be used.

In order to direct the trimmer 106, the selector handle 120 is adjusted to vary the pulling tension on the arm 108 and therefore the degree of extension of the tensioning spring 112. In this regard, as the arm 108 is rotatably mounted to the wheeled carriage 102 via the ball-bearing joint 110, when the inner cable 124 of the gear cable 118 is slack, the tensioning spring 112 pulls the arm 108 about the ball-bearing joint 110 towards, in this example, the left hand side of the wheeled carriage 102, and when tension is applied by the gear cable 118 against the force of the tensioning spring 112, the arm 108 is pulled against the resistance of the tensioning spring 112 and rotated about the ball-bearing joint 110 and so, in this example, to the right hand side of the wheeled carriage 102. As such, the operator can cause the trimmer 106 carried by the horizontally pivoting arm 108 to sweep from side-to-side in front of the wheeled carriage 102 or to direct the trimmer 106 to a specific desired location in front of the wheeled carriage 102. Hence, the mounting arm 108 is remotely controllable and has a fixed state and a pivoting state, which is in this example controllable by the selector handle 120.

As can be appreciated, the above-described mechanism to direct the arm 108 carrying the trimmer 106 horizontally constitutes a translation mechanism comprising a selectable static state and a selectable dynamic mode. Also, the mechanism is configured to permit horizontal translation of the trimmer 106 in front of the wheeled carriage 102 in response to selection of the dynamic mode. The static state, in the above example, is when the selector handle 120 is not used and the dynamic mode is when the selector handle 120 is used to move the trimmer 106.

Additionally, or alternatively, the translation mechanism can be provided by rear wheels (not shown) of the wheeled carriage 102 in cooperation with pivoting at the front of the wheeled carriage 102. In this respect, each of the rear wheels can be configured to rotate about a respective substantially vertical axis, thereby enabling the wheeled carriage 102 carrying the trimmer 106 to be pivotally directed to desired locations. The rear wheels, remotely or directly, can be locked and unlocked so that the horizontal translation of trimmer 106 can be performed selectively. As such, the translation mechanism, in this example, has a fixed state and a steering state.

As mentioned above, the downward bias spring 133 urges the arm 108 and hence the trimmer 106 in a generally downwards direction in order to maintain a desired cutting length, which can be set by a separate cut height control for the wheeled carriage 102. However, as the trimmer 106, which rides over the terrain of the lawn, encounters an area of unevenness, for example a rise in the terrain, the skid plate 140 or the wheel 146, rides over the rise in the terrain, acting against the downward bias spring 133 temporarily so that the trimmer 106 can negotiate the rise in the terrain without snagging on the ground and damaging the trimmer 104 and/or the wheeled carriage 102 losing traction. Once the trimmer 106 has ridden over the rise in the terrain, the resistance against the downward bias spring 133 via the pivot point 132 is removed and the force applied by the downward bias spring 133 urges the trimmer 106 back down towards its previous position opposite the lawn.

As will be described later herein in relation to other implementations, a tracking mechanism can be provided to rotate the guard 142 as the arm 108 carrying the trimmer 106 moves under the control of the operator in order to expose a cutting side or region of the trimmer 106 opposite a region of the lawn, for example a side border, to be trimmed. In this respect, the guard 142 rotates in response to movement of the arm 108 and, in this example, the rotation of the guard 142 is proportional to the movement of the arm 108.

In another embodiment (FIGS. 5 to 7), the arm 108 carrying the trimmer 106 is a single part configured to translate laterally on a stage or rail or pair of rails 200 mounted on the wheeled carriage 102. In this regard, a distal end of the arm 108 is slidably coupled to a first, slider, rail 202 and a substantially central region of the arm 108 is slidably coupled to a second, slider, rail 204, the second slider rail 204 being disposed in parallel relation with the first slider rail 202, the arm 108 being operably coupled to the first slider rail 202 to support lateral translation of the arm 108.

Referring to FIG. 8, the second slider rail 204 comprises a primary channel 209 therethrough through which the arm 108 passes substantially perpendicularly to the second slider rail 204. The arm 108 carries a trunnion-like pin 205 that resides in a top-channel 207 of the second slider rail 204 to guide the translation of the arm 108 along the primary channel 209 of the secondary slider rail 204. Ball-bearings can be employed to facilitate smooth sliding of the arm 108 along the second slider rail 204. The arm 108 also carries a spring-loaded adjustment arm 206 that has a locked state and a released state, the spring-loaded adjustment arm 206 having a handle 208 at one end thereof and a guard pin 210 at an opposite end thereof. The adjustment arm 206 also engages selectively with the second slider rail 204 in order to hold the arm 108 at a fixed location along the second slider rail 204 when the spring-loaded adjustment arm 206 is in the locked state. The spring-loaded adjustment arm 206 comprises an outer sleeve 212 and an inner pin 214, the outer sleeve 212 having a first circumferential shoulder 216 to which a first end of a third biasing means, for example a third spring 218, is coupled. The inner pin 214 also carries a second circumferential shoulder 220 opposite the first circumferential shoulder 216, a second end of the third spring 218 being coupled to the second circumferential shoulder 220 so as to force the first and second circumferential shoulders 216, 220 together. The second slider rail 204 comprises a plurality of longitudinally spaced rearward-facing recesses to receive the second circumferential shoulder 220 when in a locked state.

Although not shown, the guard 142 is rotatably mounted and comprises a plurality of circumferentially spaced recesses into which to receive an end of the guard pin 210 to lock the guard 142 in place. The guard 142 also comprises a peripheral channel 222 and the arm 108 carries a downwardly depending pin 224, which passes through a secondary channel 226. A rotatable disc 228 is carried by the downwardly depending pin 224, substantially mid-way along the length of the downwardly depending pin 224 in this example. The downwardly depending pin 224 therefore serves as an axel for the rotatable disc 228. The distal radial periphery of the rotatable disc 228 cooperates frictionally with the peripheral channel 222 of the guard 142.

In this example, the trimmer 106 is pivotally mounted 229 to the arm 108 at an opposite end to the adjustment arm 206, the axis of pivoting about which the trimmer 106 can rotate being substantially horizontal.

In operation, and as described above in relation to the previous examples, the mower 100 is powered by the primary drive system to provide locomotion of the wheeled carriage 102, when a locomotion mode is activated, so as to travel across a lawn (not shown) having a terrain that is typically uneven. As the wheeled carriage 102 passes over the lawn with the primary cutting tool 105 rotating the grass is cut and, optionally, stored in a grass collection bag (not shown) to the rear of the mower. When a portion of the lawn needs to be trimmed, for example a border or a central feature having an edge that requires trimming, an operator of the mower activates the trimmer 106, for example using the actuator mentioned above on the selector handle 120, in order to power up the trimmer 106. Once the trimmer 106 reaches operational rotational speed, the trimmer can be used. It should however be appreciated that, in this example, the selector handle 120 simply serves to control application of power to the trimmer 106, and the mechanism to translate the arm 108 of the previous examples is not provided.

In this regard, in order to direct the trimmer 106, the operator pulls the handle 208 of the adjustment arm 206, which overcomes the force of the third spring 218 urging the outer sleeve 212 and the inner pin 214 apart, pulling the second circumferential shoulder 220 out of a recess of the plurality of longitudinally spaced rearward-facing recesses of the second slider rail 204, so as to release the arm 108 carrying the trimmer 106 from a locked state to a dynamic mode where the arm 108 and trimmer 106 can be slid from side-to-side in front of the wheeled carriage 102 until a desired location for the trimmer 106 has been found. When the adjustment arm 206 is pulled, the guard pin 210 withdraws from one of the circumferentially spaced recesses in the guard 142 and hence disengages with the guard 142. Whilst the arm 108 is translating along the second slider rail 204, the rotatable disc 228 rotates, and by contact with the peripheral channel 222 in the guard 142 and friction, causes the guard 142 to rotate, thereby exposing a frontmost part of the trimmer 106 when the arm 108 is centrally positioned and leftmost or rightmost portions of the trimmer 106 when the arm 108 is located to the left or right of the wheeled carriage 102, respectively. Once the arm 108 and trimmer 106 have been moved to a desired location in front of the wheeled carriage 102, the adjustment arm 206 is released causing the second circumferential shoulder 220 to be received by another recess of the plurality of longitudinally spaced rearward-facing recesses of the second slider rail 204 opposite the second circumferential shoulder 220. The arm 108 also locks into place when the guard pin 210 is urged by the force of the third spring 218 to engage in a recess of the guard 142 opposite the guard pin 210.

As the trimmer 106 is pivotally mounted 229 on the arm 108, should the trimmer 106 need to be tilted downwardly, the trimmer 106 can be pivoted about the horizontal pivoting axis of the pivotal mount.

Referring to FIGS. 9 and 10, in an alternative embodiment fixed ports are provided to the front of the wheeled carriage 102, for example a first fixed port 300 and a second fixed port 302. The first and second fixed ports 300, 302 are provided to receive and carry the trimmer 106. The first and second fixed ports 300, 302 are configured to drive the trimmer 106, the method of drive being electrical or mechanical depending upon implementation preferences. In this example, the first and second fixed ports 300, 302 are respectively substantially corner mounted, although in other implementations one or more of the fixed ports 300, 302 need not be disposed at a corner of the wheeled carriage 102. The arm 108 carrying the trimmer 106 is also configured to be plugged and unplugged into either of the first and second fixed ports 300, 302. In FIG. 9, the arm 108 and trimmer 106 is plugged into the first fixed port 300, which is the left port relative to the front of the wheeled carriage 102 and in FIG. 10, the arm 108 carrying the trimmer 106 is plugged into the second fixed port 302, which is the right port relative to the front of the wheeled carriage 102.

Although in this example, only two fixed ports disposed in spaced relation are described, the skilled person will appreciate that any number of fixed ports can be provided. As in previous examples, a biasing arrangement can be provided to urge the trimmer 106 in a generally downward direction in order to maintain a desired cutting length.

Turning to FIG. 11, the arm 108 carrying the trimmer 106 comprises, in this example, two parts, namely the first elongate portion 126 and the second elongate portion 128 which again share a common longitudinal axis, the first longitudinal portion 126 being operably coupled to the trimmer 106 at a first end thereof and to the second elongate portion 128 at a second end thereof via an axially rotating and lockable joint 130. The second elongate portion 128, in this example, comprises a hinge 304 that joins a first sub-portion 306 and a second sub-portion 308 of the second elongate portion 128. A first end of the first sub-portion 306 is operably coupled to the lockable joint 130 and a second end of the first sub-portion 306, distal from the first end, is coupled to the hinge 304. A first end of the second sub-portion 308 is coupled to the hinge 304 and a second end, distal from the first end, of the second sub-portion 308 comprises electrical and/or mechanical connectors 310 to mate with the first and second fixed ports 300, 302, which both comprise complementary connectors (not shown) to facilitate securing the arm 108 to the first and second fixed ports 300, 302. In this regard, the trimmer 106 can be driven electrically or mechanically, depending upon implementation choice. A further biasing means, for example a fourth spring 312 is anchored at opposing ends of the first sub-portion 306 and the second sub-portion 308 so as to bridge the hinge 304.

In operation, and as described above in relation to the previous examples, the mower 100 is powered by the primary drive system to provide locomotion of the wheeled carriage 102, when a locomotion mode is activated, so as to travel across a lawn (not shown) having a terrain that is typically uneven. As the wheeled carriage 102 passes over the lawn with the primary cutting tool 105 rotating the grass is cut and, optionally, stored in a grass collection bag (not shown) to the rear of the mower. When a portion of the lawn needs to be trimmed, for example a border or a central feature having an edge that requires trimming, an operator of the mower stops the mower 100 and attaches the arm 108 carrying the trimmer 106 to, for example, the first fixed port 300 to the left hand side of the wheeled carriage 102, and activates the trimmer 106, for example using the actuator mentioned above on the selector handle 120, in order to power up the trimmer 106. Once the trimmer 106 reaches operational rotational speed, the trimmer 106 can be used. Thereafter, should the operator require the capability to trim to the right hand side of the wheeled carriage 102, the operator can stop the mower 100 and power down the trimmer 106 before detaching the arm 108 carrying the trimmer 106 from the first fixed port 300 and connect the arm 108 carrying the trimmer 106 to the second fixed port 302. The operator then powers up the trimmer 106 again and can use the trimmer 106 once the trimmer 106 reaches operational rotational speed.

The fourth spring 312 cooperates with the hinge 304 in order to urge the trimmer 106 in a generally downward direction in order to maintain a desired cutting length. In the event that the operator needs to move the trimmer 106 away from the front of the wheeled carriage 102, the first sub-portion 306 of the second elongate portion 128 of the arm 108 can be rotated by approximately 90 degrees about the hinge 304 to a substantially vertical orientation. The tension provided by the fourth spring 312 maintains the substantially vertical orientation of the first sub-portion 306 relative to the second sub-portion 308. In this example, as in previous examples, the trimmer 106 or the arm 108 comprises a ground-engaging underside surface element, for example the skid pan or plate 140 or the wheel 146 described above.

In the above examples, where the axially rotatable lockable joint 130 is provided, the joint 130 can be unlocked by rotating a collar 314 to enable rotation of the first portion 126 of the arm 108 and the trimmer 106 relative to the second portion 128. In this regard, the joint 130 can be a twist lock clamp. The joint 130 is used to orient the trimmer 106 at any desired angle about the longitudinal axis of the arm 108, for example so as to orient the trimmer 106 such that a cutting plane of the trimmer 106 is substantially vertical as opposed to substantially horizontal, thereby enabling trimming of vegetation that grows horizontally outward at a border or an edge as opposed to growing vertically upward as in the case of lawn.

The skilled person should appreciate that the above-described implementations are merely examples of the various implementations that are conceivable within the scope of the appended claims. Indeed, it should be appreciated that, for example, although in a number of examples a single translating trimmer is described, the skilled person will appreciate that the wheeled carriage 102 can be provided with more than one translating trimmer. In other embodiments, the mower 100 can comprise a light source, for example a forward-facing light source to facilitate identification by the operator that the trimmer 106 is spinning and potentially hazardous. In this respect, the light source can be coupled to the front of the wheeled carriage 102 and, in some examples, the light source can be configured to strobe or flash at a predetermine safe frequency in order to further enhance identification of the movement of the flex of the trimmer 106. In the above examples, the ground-engaging underside surface element is either operably coupled to the trimmer 106 or the arm 108. However, in other embodiments, the ground-engaging underside surface element can be coupled to other parts of the mower 100, for example the ground-engaging underside surface element can be operably coupled to the wheeled carriage 102 in either a deployed state or can be remotely deployable.

1-17. (canceled)

18. A lawn mower comprising:
a wheeled carriage configured to carry a primary cutting tool for cutting lawn, the primary cutting tool being operably coupled to a primary drive system;
a trimmer operably coupled to the wheeled carriage;
a translation mechanism comprising a selectable static state and a selectable dynamic mode, the translation mechanism being operably coupled to the trimmer and configured to permit horizontal translation of the trimmer in front of the wheeled carriage in response to selection of the dynamic mode;
a mounting arm configured to carry to the trimmer;
a ground-engaging underside surface element configured to ride over contours of a lawn, when in use, without snagging; and
a bias unit configured to bias the mounting arm downwardly.

19. The lawn mower according to claim 18, wherein the trimmer is removably coupled to the wheeled carriage.

20. The lawn mower according to claim 18, wherein the translation mechanism comprises rear wheels of the wheeled carriage having a fixed state and a steering state.

21. The lawn mower according to claim 18, wherein the translation mechanism comprises the mounting arm horizontally pivotally mounted.

22. The lawn mower according to claim 21, wherein the mounting arm has a fixed state and a pivoting state.

23. The lawn mower according to claim 18, wherein the mounting arm is configured to power the trimmer.

24. The lawn mower according to claim 21, wherein the pivotally mounted arm is configured to sweep from side-to-side.

25. The lawn mower according to claim 21, wherein movement of the pivotally mounted arm is controllable remotely.

26. The lawn mower according to claim 21, wherein the pivotally mounted arm is centrally mounted.

27. The lawn mower according to claim 18, further comprising:
a secondary drive system configured to drive the trimmer, the secondary drive system being independently controllable from the primary drive system.

28. The lawn mower according to claim 18, wherein the ground-engaging underside element is a skid pan.

29. The lawn mower according to claim 18, further comprising a front mounted light source.

30. A lawn mower comprising:
a wheeled carriage configured to carry a primary cutting tool for cutting lawn, the primary cutting tool being operably coupled to a primary drive system;
a first fixed mounting point located at the front of the wheeled carriage relative to a primary direction of locomotion of the wheeled carriage;
a second fixed mounting point located at the front of the wheeled carriage;
a trimmer removably couplable to the first fixed mounting point or the second fixed mounting point;
a mounting arm configured to carry to the trimmer;
a ground-engaging underside surface element configured to ride over contours of a lawn, when in use, without snagging; and
a bias unit configured to bias the mounting arm downwardly; wherein
the first and second fixed mounting points are disposed in spaced relation to each other.

31. The lawn mower according to claim 30, wherein
the first and second fixed mounting points are configured to power the trimmer when coupled respectively to the first and second fixed mounting points.

32. The lawn mower according to claim 30, further comprising:
a plurality of fixed mounting points disposed about the front of the wheeled carriage, the plurality of fixed mounting points comprising the first and seconds fixed mounting points and each of the plurality of fixed mounting points being configured to carry the trimmer.

33. The lawn mower according to claim 30, wherein a fixed mounting point of the first and second fixed mounting points is substantially corner mounted with respect to the wheeled carriage.

34. The lawn mower according to claim 30, further comprising a bias unit configured to bias downwardly the trimmer when coupled to a mounting point of the plurality of mounting points.
